(19) United States
(12) Patent Application Publication
(10) Pub. No.: US 2019/0001741 A1
(43) Pub. Date: Jan. 3, 2019

(54) Method for Providing a Metal Piece of a Musical Instrument with a Pattern that Exhibits Various Visual Effects

(71) Applicant: C H Y Trade Co., Ltd., Taichung City (TW)

(72) Inventor: Ying-Ling Chen, Taichung City (TW)

(21) Appl. No.: 16/016,733

(22) Filed: Jun. 25, 2018

(30) Foreign Application Priority Data
Jun. 30, 2017 (TW) 106122036

(51) Int. Cl. B44D 5/10; B44F 1/02; B44C 1/22; G10G 7/00

(52) U.S. Cl. CPC B44D 5/10; G10G 7/00; B44C 1/22; B44F 1/02

(57) ABSTRACT

A metal piece is provided with a pattern that exhibits different visual effects when it is viewed at different angles. At first, an as-cast metal piece is provided. Then, the metal piece is polished. The metal piece is cleaned. A layer is provided on the metal piece by providing colorant on the metal piece. An outline is provided on the bottom layer. A portion of the bottom layer is removed from the outline. Grooves are made in the outline before the metal piece is cleaned again. The grooves extend in a desired sense of direction and are at a desired depth. A colored pattern is provided by filling colorant in the outline. The colored pattern is dried. Grooves are made in the colored pattern before the metal piece is cleaned again. A protective layer is provided on the bottom layer and the colored pattern. The protective layer is dried.

### CROSS-REFERENCE TO RELATED APPLICATION

This application claims priority of Taiwanese Application No. 106122036, filed on Jun. 30, 2017.

### BACKGROUND OF INVENTION

### 1. Field of Invention

The present invention relates to a musical instrument and, more particularly, to a method for providing a metal piece of a musical instrument with a pattern that exhibits different visual effects when it is viewed at different angles.

### 2. Related Prior Art

To increase visual effects of a musical instrument for aesthetic or characteristic purposes, the musical instrument is provided with letters and/or patterns in a proper finishing process such as inscription, painting, spraying and dye-sublimation. However, such finishing process provides the musical instrument with various values of thickness. For example, inscription reduces the thickness of the musical instrument. Painting and spraying considerably increase the thickness of the musical instrument if many layers of paint are provided on the musical instrument in many rounds of painting or spraying. The sound quality and resonance of the musical instrument can and will be affected if such changes in the thickness occur in a resonance portion, a vibration portion or a sound-producing portion of the musical instrument.

Moreover, none of the inscription, painting, spraying and dye-sublimation can provide the musical instrument with a pattern that exhibits different visual effects when it is viewed at different angles although they can be used to provide the musical instrument with letters and/or patterns.

The present invention is therefore intended to obviate or at least alleviate the problems encountered in prior art.

### SUMMARY OF INVENTION

It is an objective of the present invention to provide a method for providing a metal piece of a musical instrument with a pattern that exhibits different visual effects when it is viewed at different angles.

To achieve the foregoing objective, the method includes the step of providing an as-cast metal piece. Then, the metal piece is polished so that the metal piece is provided with roughness of 2.0 to 6.3. The metal piece is cleaned. A bottom layer is provided on the metal piece by providing colorant on the metal piece. The bottom layer is provided with thickness of 0.05 mm to 0.2 mm. An outline is provided on the bottom layer. A portion of the bottom layer is removed from the outline. Grooves are made in the outline before the metal piece is cleaned again. The grooves extend in a desired sense of direction and are at a desired depth. A colored pattern is provided by filling colorant in the grooves. The colored pattern is dried. Grooves are made in the colored pattern before the metal piece is cleaned again. A protective layer is provided on the bottom layer and the colored pattern. The protective layer protects the bottom layer and the colored pattern and renders the metal piece glistering and smooth. The protective layer is dried. Total thickness of the bottom layer, the colored pattern and the protective layer is 0.3 mm to 0.5 mm.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is a flow chart of a method for providing a metal piece of a musical instrument with a pattern that exhibits different visual effects when it is viewed at different angles according to the preferred embodiment of the present invention;

FIG. 2 is a perspective view of a metal piece of a saxophone to be process in the method shown in FIG. 1;

FIG. 3 is a perspective view of the metal piece shown in FIG. 2, with a bottom layer provided thereon;

FIG. 4 is a perspective view of the metal piece shown in FIG. 3, with outlines provided on the bottom layer;

FIG. 5 is a perspective view of the metal piece shown in FIG. 4, with portions of the bottom layer removed from the outlines;

FIG. 6 is an enlarged, partial and cross-sectional view of the metal piece shown in FIG. 5, with grooves made in one of the outlines;

FIG. 7 is a perspective view of the metal piece shown in FIG. 6, with colorant filled in the outlines; and

FIG. 8 is an enlarged, partial and cross-sectional view of the metal piece shown in FIG. 7, with grooves made in the layer of colorant.

### DETAILED DESCRIPTION OF PREFERRED EMBODIMENT

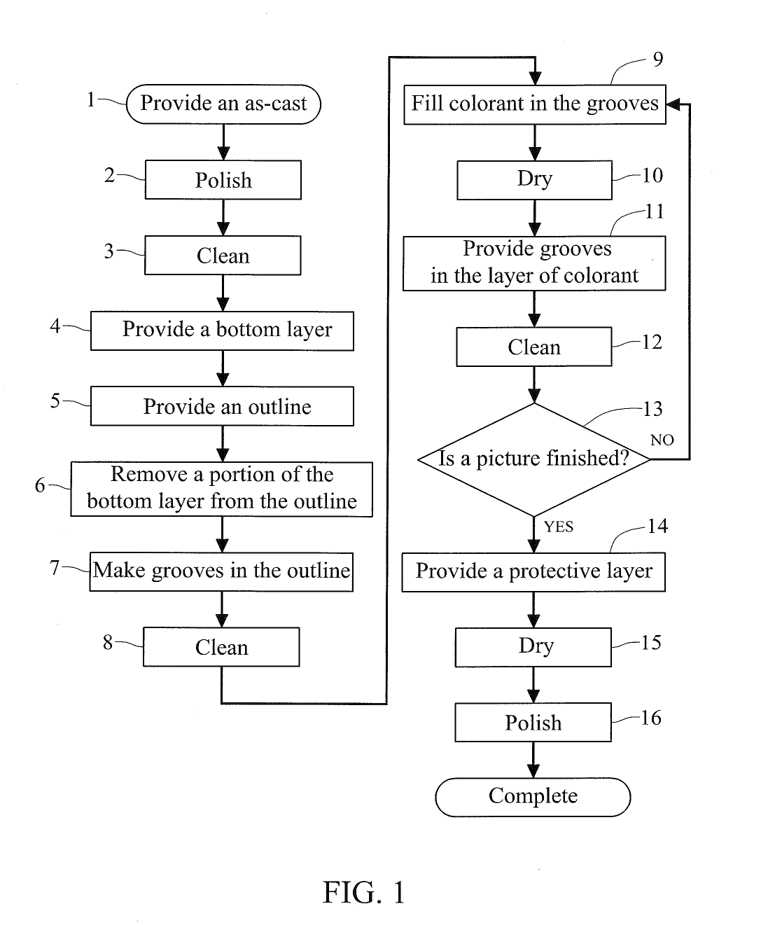

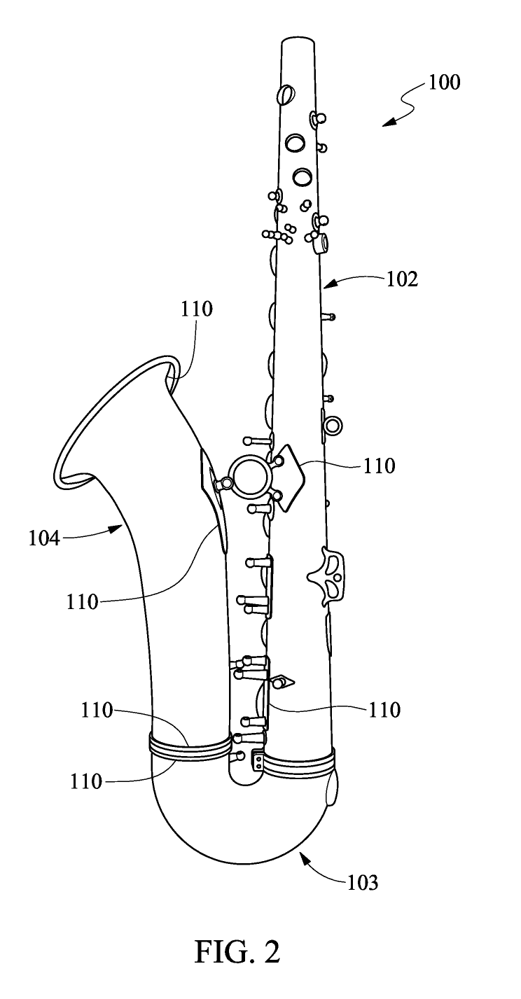

Referring to FIG. 1, shown is a method for providing a metal piece of a musical instrument with a pattern that exhibits different visual effects when it is viewed at different angles according to the preferred embodiment of the present invention. The musical instrument is a wind instrument, a drum, a guitar, a cymbal, or a hang drum for example. For briefness, clarity and example, a saxophone will be taken as the musical instrument in the following description referring to FIGS. 2 to 8. The saxophone includes a metal piece 100 that includes a body 102, a bow 103 and a bell 104.

Referring to FIGS. 1 and 2, at 1, an as-cast of the metal piece 100 is provided. Now, the as-cast of the metal piece 100 has not been polished or coated.

Referring to FIG. 1, at 2, the as-cast of the metal piece 100 is polished. Thus, the roughness Ra of the surface of the metal piece 100 is 2.0 to 6.3. The polishing is executed by using a polishing element such as sand paper, a dry mill, an electric drill, an engraving machine or any other proper device. At 2, scraping is executed in addition. A blade or any other proper scraping element is used to scraping portions 110 of the metal piece 100 beyond the reach of the grinding element. Thus, the roughness of the portions 110 can reach 2.0 to 6.3. For example, the portions 110 include edges around apertures in the metal piece 100, arched portions of high curvature, narrow facets, angles and portions where accessories are connected to the metal piece 100.

Referring to FIG. 1, at 3, the metal piece 100 is subjected to a first round of cleaning. Thus, dust is removed from the metal piece 100. The first round of cleaning includes but not limited to washing the metal piece 100 with 95% alcohol solution.

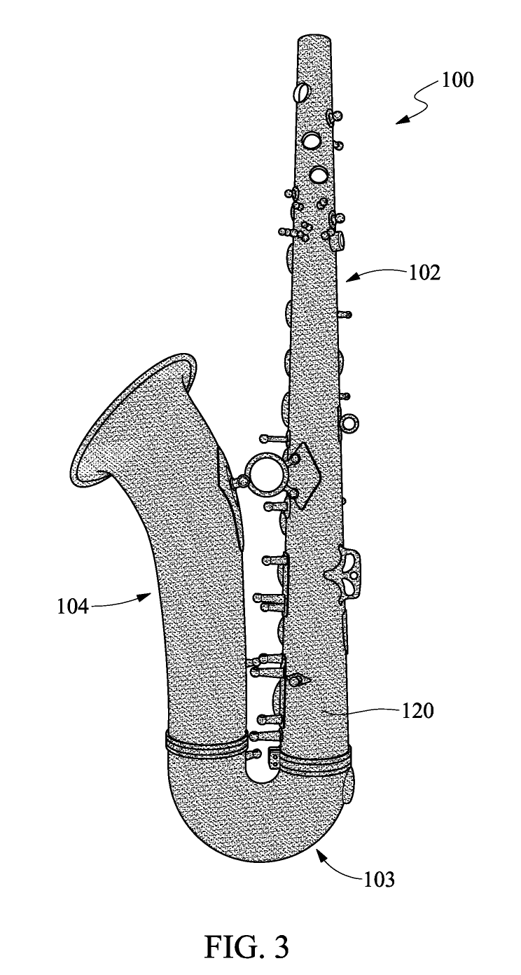

Referring to FIGS. 1 and 3, at 4, colorant such as paint and dye is provided on the entire surface of the metal piece 100 by spraying for example. Then, the colorant is dried and cured to form a bottom layer 120. The thickness of the bottom layer 120 is 0.05 mm to 0.2 mm. The bottom layer 120 can be provided by several rounds of spraying of several types of colorant. However, each round of spraying is executed after the colorant in a previous round of spraying is dried. The bottom layer 120 exhibits but not limited to at least one shade of at least one color or gradient.

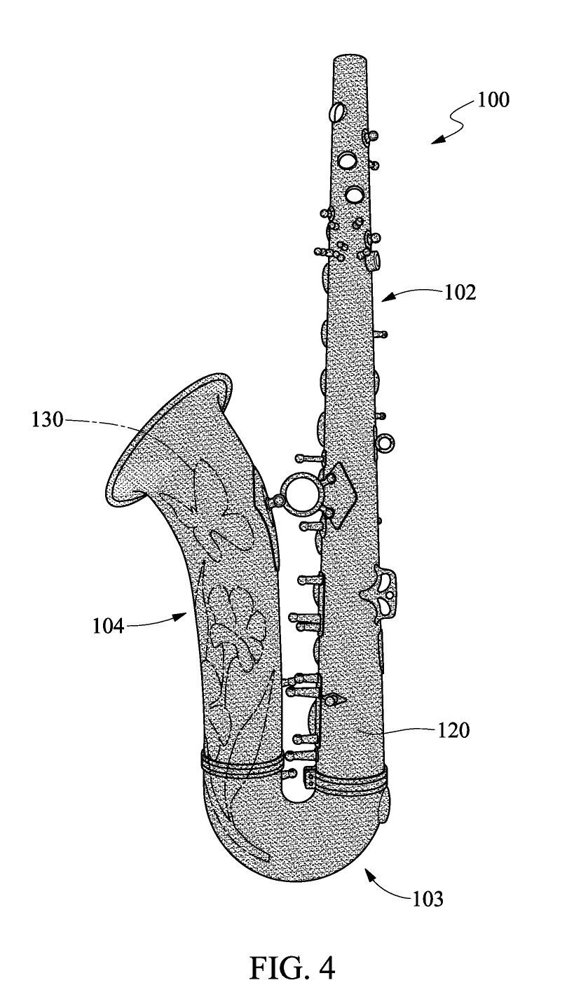

Referring to FIGS. 1 and 4, at 5, outlines 130 are provided on the bottom layer 120 by lofting. The outlines 130 are provided on the bottom layer 120 by sketching or using transfer paper for example.

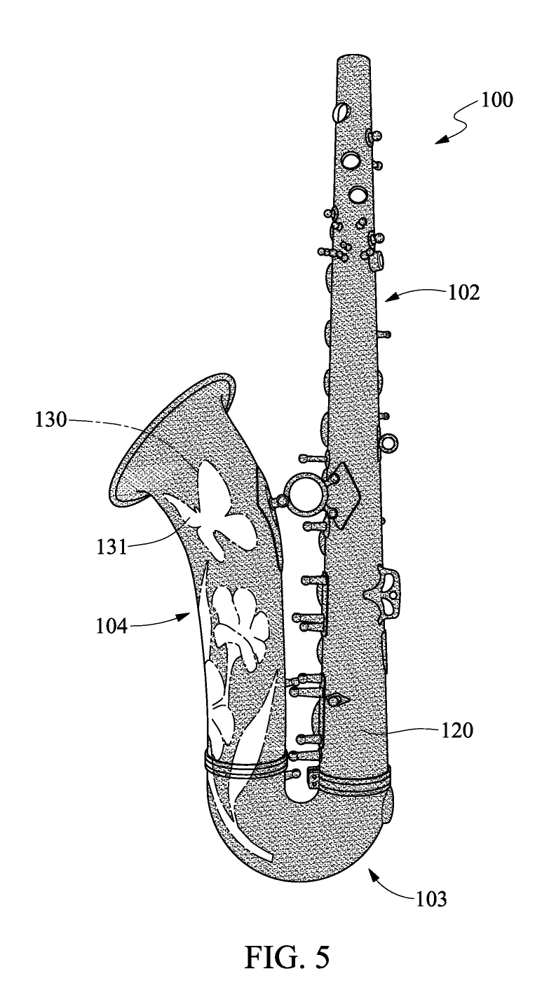

Referring to FIGS. 1 and 5, at 6, portions of the bottom layer 120 are removed from regions 131 in the outlines 130. The portion of the bottom layer 120 is removed from the regions 131 by using a metal surface cleaner such as a paint remover.

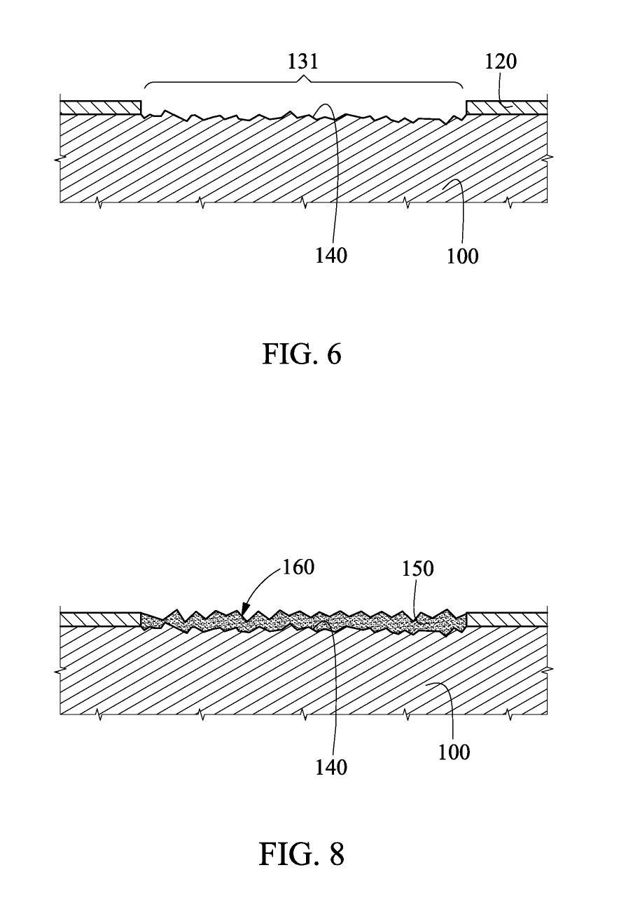

Referring to FIGS. 1 and 6, at 7, grooves 140 are made in each of the regions 131 from which the portion of the bottom layer 120 has been removed. The grooves 140 are made by a grinding device or an inscribing device. The grooves 140 extend in a desired sense of direction and are at a desired depth. The grooves 140 can be thin and dense, or wide and sparse. Thus, the regions 131 reflect light in a desired manner. The light reflected from the regions 131 provides different visual effects when it is viewed at different angles.

Referring to FIG. 1, at 8, the metal piece 100 is subjected to a second round of cleaning to remove dust produced at the previous step. The second round of cleaning includes but not limited to washing the metal piece 100 with 95% alcohol solution.

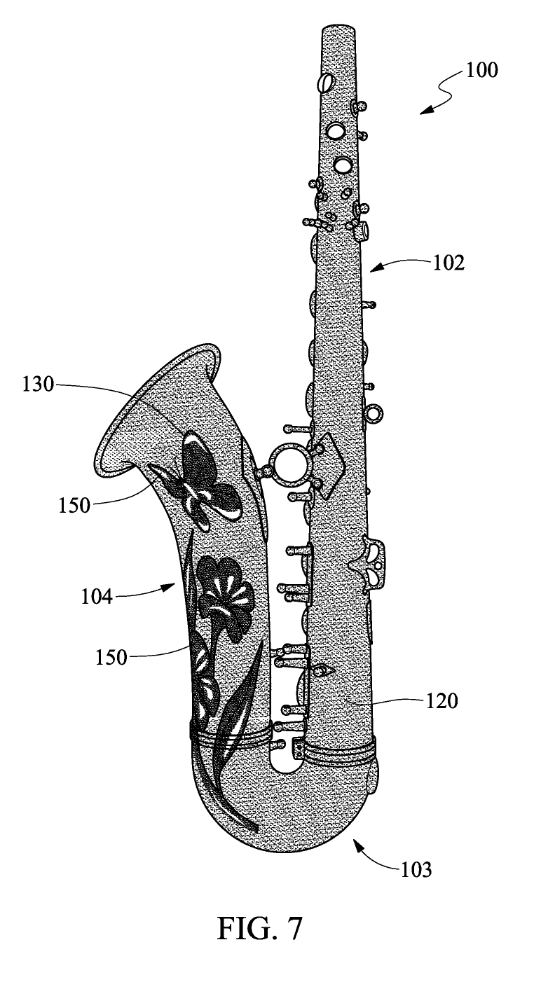

Referring to FIGS. 1 and 7, at 9, the regions 131 are filled with colorant preferably of a different color from that of the bottom layer 120. Of course, the grooves 140 are filled with the colorant. Thus, colored patterns 150 are provided in the regions 131.

Referring to FIG. 1, at 10, the colored patterns 150 in the regions 131 are dried and cured. The drying of the colored patterns 150 includes but not limited to natural wind or hot drying at 60° C.

Referring to FIGS. 1 and 8, at 11, grooves 160 are provided in each of the colored patterns 150. The grooves 160 are made by a grinding device or an inscribing device. The grooves 160 extend in a desired sense of direction and are at a desired depth. The grooves 160 can be thin and dense, or wide and sparse. Thus, the regions 131 reflect light in a desired manner. The light reflected from the regions 131 provides different visual effects when it is viewed at different angles.

Referring to FIG. 1, at 12, the metal piece 100 is subjected to a third round of cleaning to remove dust produced at the previous step. The third round of cleaning includes but not limited to washing the metal piece 100 with 95% alcohol solution.

Referring to FIG. 1, at 13, it is determined whether a desired picture 200 is completed. If not, the routine goes back to the step of providing colorant in the regions 131, and the four previous steps are repeated so that all of the colored patterns 150. If yes, the routine goes to the following step. The picture 200 exhibits vivid and dazzling visual effects by using the grooves 140 and 160 and the colorant.

Referring to FIG. 1, at 14, a protective layer is provided over the bottom layer 120 and the picture 200. Thus, the protective layer protects the bottom layer 120 and the picture 200, and provides a smooth and glistering surface. The protective layer includes but not limited to a clear coat provided by spraying.

Referring to FIG. 1, at 15, the protective layer is dried. The drying of the protective layer includes but not limited to natural wind or hot drying at 60° C. Preferably, the spraying and drying of the protective layer are executed in several rounds so that the protective layer is even, thin and transparent. The total thickness of the bottom layer 120, the picture 200 and the protective layer is 0.3 mm to 0.5 mm. Such total thickness does not considerably affect the sound quality and resonance of the saxophone.

Referring to FIG. 1, at 16, the protective layer is polished. The polishing of the protective layer is executed via sandpaper of P600 to P1000. Thus, the protective layer is rendered smoother.

As described above, the metal piece 100 is provided with the picture 200 that exhibits different visual effects when it is viewed at different angles. The picture 200 exhibits vivid and dazzling visual effects, without considerably affecting the sound quality and resonance of the saxophone.

The present invention has been described via the illustration of the preferred embodiment. Those skilled in the art can derive variations from the preferred embodiment without departing from the scope of the present invention. Therefore, the preferred embodiment shall not limit the scope of the present invention defined in the claims.

1. A method for providing a metal piece of a musical instrument with a pattern that exhibits different visual effects when it is viewed at different angles sequentially comprising the steps of:
providing an as-cast metal piece of a musical instrument;
polishing the metal piece so that the metal piece is provided with roughness of 2.0 to 6.3;
cleaning the metal piece;
providing a bottom layer on the metal piece by providing colorant on the metal piece, wherein the bottom layer is provided with thickness of 0.05 mm to 0.2 mm;
providing an outline on the bottom layer;
removing a portion of the bottom layer from the outline;
making grooves in the outline, wherein the grooves extend in a desired sense of direction and are at a desired depth;
cleaning the metal piece;
providing a colored pattern by filling colorant in the outline;
drying the colored pattern;
making grooves in the colored pattern;
cleaning the metal piece;
providing a protective layer on the bottom layer and the colored pattern, wherein the protective layer protects the bottom layer and the colored pattern and renders the metal piece glistering and smooth; and
drying the protective layer, wherein total thickness of the bottom layer, the colored pattern and the protective layer is 0.3 mm to 0.5 mm.

2. The method according to claim 1, wherein the step of polishing the metal piece comprising the step of scraping portions of the metal piece beyond the reach of grinding.

3. The method according to claim 1, wherein each of the steps of cleaning the metal piece comprises the step of washing the entire metal piece with 95% alcohol solution.

4. The method according to claim 1, wherein the step of providing the outline is selected from the group consisting of sketching and using transfer paper.

5. The method according to claim 1, wherein the step of removing the portion removing a portion of the bottom layer from the outline comprises the step of washing the bottom layer with metal surface cleaner.

6. The method according to claim 1, wherein the step of making grooves in the outline comprising the step of using a device selected from the group consisting of a grinding device and an inscribing device.

7. The method according to claim 1, wherein the step of drying the protective layer is selected from the group consisting of natural wind and hot drying at 60° C.

8. The method according to claim 1, wherein the step of providing a protective layer comprises the step spraying a clear coat.

9. The method according to claim 1, further comprising the step of polishing the protective layer with sandpaper of P600 to P1000.

10. The method according to claim 1, wherein the musical instrument is selected from the group consisting of a wind instrument, a drum, a stringed instrument, a self-acoustic instrument and a hang drum.

11. The method according to claim 1, wherein the four sequential steps of providing colored pattern, drying the colored pattern, making grooves in the colored pattern, and cleaning the metal piece are repeated to provide colored patterns that together form a larger picture.
